(19) United States
(12) Patent Application Publication
(10) Pub. No.: US 2026/0108894 A1
(43) Pub. Date: Apr. 23, 2026

(54) Injector for spraying device and associated spraying device

(71) Applicant: EXEL INDUSTRIES, EPERNAY (FR)

(72) Inventors: Cyrille MEDARD, EPERNAY (FR); Sylvain PERINET, EPERNAY (FR); David VINCENT, EPERNAY (FR); Olivier GOURBAT, EPERNAY (FR); Denis VANZETTO, EPERNAY (FR); Philippe FOURY, EPERNAY (FR)

(21) Appl. No.: 19/357,664

(22) Filed: Oct. 14, 2025

(30) Foreign Application Priority Data
Oct. 21, 2024 (FR) 2411411

(51) Int. Cl. B05B 1/14; B05B 7/04; B05B 7/10

(52) U.S. Cl. CPC B05B 1/1421; B05B 7/04; B05B 7/10

(57) ABSTRACT

An injector for a multi-component coating product spraying device, the injector having a longitudinal direction, the injector having an inlet. The injector has a plurality of outlet orifices, the injector being adapted to be supplied with a component product at the inlet, so that the component product exits the injector through the outlet orifices, each outlet orifice forming a given angle with respect to the longitudinal direction of between 10° and 90°, preferably between 30° and 90°. The invention also describes and claims an associated spraying device.

### CROSS-REFERENCE TO RELATED APPLICATION

This application is a U.S. non-provisional application claiming the benefit of French Application No. 24 11411, filed on Oct. 21, 2024, which is incorporated herein by reference in its entirety.

### TECHNICAL FIELD OF THE INVENTION

The present invention relates to an injector for a multi-component coating product spraying device and an associated spraying device. The injector has an inlet and a longitudinal direction.

### BACKGROUND OF THE INVENTION

The injector thus enables one of the components to be injected, in particular into an injection chamber, into which at least one other of the components is injected.

This allows the components to mix in the injection chamber.

The quality of the mix is important for the quality and durability of the coating product.

However, the components are regularly less and less miscible. In particular, the quest for aesthetic and/or mechanical properties in coating products leads to the addition of fillers, such as pigments or glass fibers or other effect fillers. These charges reduce the miscibility of the components.

The quality of the mix between the components is therefore crucial.

To improve mixing in a spraying device, one possibility is to carry out mixing well in advance of spraying, so as to increase the mixing time to promote mixing both mechanically and chemically.

However, once the components come into contact, the mixture generally has a limited lifespan. For example, for a product composed of resin and hardener, once the two components are assembled, the product hardens.

This is therefore likely to be problematic, both for low flow rates and for coating products with a very limited lifespan once mixed. The coating product can then be fully or partially hardened before being sprayed.

### SUMMARY OF THE INVENTION

The aim of the invention is therefore to propose a solution for a spraying device that improves the quality of the mixture and of the sprayed coating product.

To this end, the invention relates to an injector for a multi-component coating product spraying device, the injector having a longitudinal direction, the injector having an inlet, characterized in that the injector has a plurality of outlet orifices, the injector being adapted to be supplied with a component product at the inlet, so that the component product leaves the injector via the outlet orifices, each outlet orifice forming a given angle with respect to the longitudinal direction of between 10° and 90°, preferably between 30° and 90°.

The injector is able to eject the component product at several points, at an angle to the longitudinal direction of the injector. This encourages mixing with a second component in the injection chamber, as mentioned above.

In other beneficial aspects of the invention, the injector comprises one or more of the following features, taken in isolation or in any technically possible combination:
the injector comprises a central channel extending from the inlet and secondary channels, each secondary channel connecting a respective outlet orifice to the central channel;
each secondary channel extends in a plane, the plane forming the given angle with the longitudinal direction;
the central channel extends in the longitudinal direction;
the cross-sectional area of the central channel is equal to the sum of the cross-sectional areas of the secondary channels;
the outlet orifices are distributed around the circumference of the injector at regular angular intervals, the angular interval preferably being equal to 360° divided by the number of outlet orifices;
the injector comprises between two and five outlet orifices, preferably three outlet orifices;
each outlet orifice also forms a second given angle with respect to a respective radial direction, the respective radial direction being the direction perpendicular to the longitudinal direction and a local tangential direction, the local tangential direction corresponding to the tangential direction of the injector at the point where the said outlet orifice emerges, the second given angle being other than 0° and less than or equal to 35°, preferably between 0° and 20°, and even more preferably between 5° and 15°;
the injector comprises a central channel extending from the inlet, the cross-sectional area of the central channel being strictly less than any cross-sectional area of the inlet; and/or
the injector comprises a thread for mounting and dismounting the injector on an inlet of an injection chamber.

The invention also relates to a multi-component coating product spraying device comprising a spraying element, an injector, and an injection chamber upstream of the injector, the injector being adapted to inject the coating product into the spraying element, the spraying element being adapted to spray the coating product, the injection chamber comprising a first inlet for a first component of the coating product and a second inlet for a second component of the coating product, the first inlet being provided with an injector as previously defined, the first component being injected into the injection chamber via the injector.

According to other advantageous aspects of the invention, the spraying device comprises the following features: the spraying device is provided with an injector as defined above, the second inlet being such that the second component forms a vortex in the injection chamber, the outlet orifices being such that the first component is injected with a flow having a radial component opposite to the vortex.

### BRIEF DESCRIPTION OF THE DRAWINGS

The invention will appear more clearly when reading the description that follows, given solely as a non-limiting example and made in reference to drawings in which:

FIG. 1 is a cross-sectional view of part of a spraying device according to an example of the invention,

FIG. 2 is a cross-sectional view of a first example of an injector according to the invention,

FIG. 3 is a schematic top view of the injector channels in FIG. 2,

FIG. 4 is a cross-sectional view of a second example of an injector according to the invention, and

FIG. 5 is a representation of the injector of FIG. 4 perpendicular to the longitudinal direction X, showing the secondary channels and outlet orifices.

### DETAILED DESCRIPTION

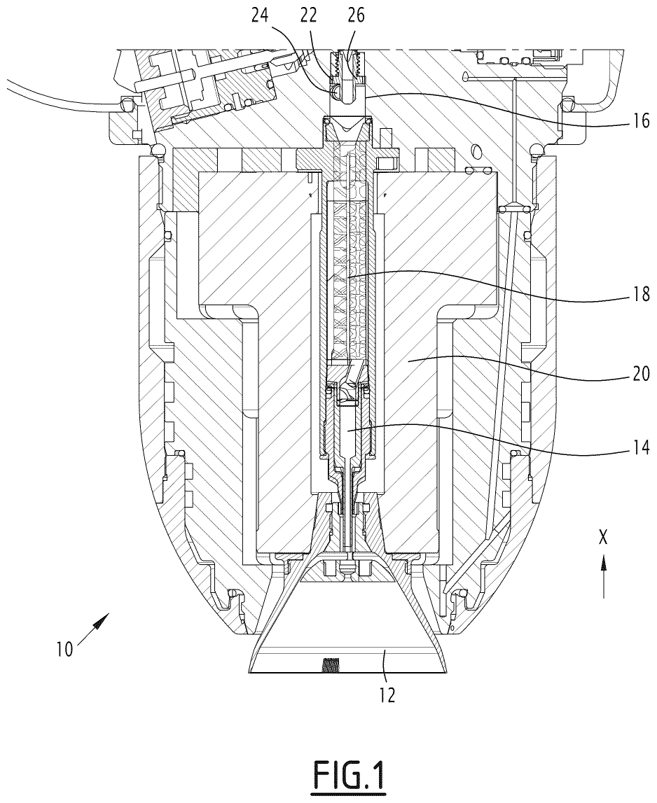

A device 10 for spraying a multi-component coating product according to one example of the invention is partially shown in FIG. 1.

The spraying device 10 comprises a spraying element 12, an injector 14 and an injection chamber 16 upstream of the injector.

The spraying device 10 further comprises a mixer 18 between the injection chamber 16 and the injector 14.

The spraying element 12 is adapted to spray the coating product, more particularly the coating product supplied by the injector 14.

The spraying element 12 is, for example, a spray bowl.

The spray bowl can be rotated about an axis of rotation.

More particularly, the spraying device 10 further comprises a turbine 20 for rotating the spraying element 12.

The injector 14 is adapted and arranged to inject the coating product to be sprayed into the spraying element 12.

The injector 14 is supplied with coating product via the injection chamber.

The injection chamber 16 comprises a first inlet 22 for a first component of the coating product and a second inlet 24 for a second component of the coating product.

The first and second components are fluid.

The first component is, for example, a hardener.

The second component is, for example, a resin.

Here, the coating product is made up of the first component and the second component.

Alternatively, the coating product comprises more than two components. The injection chamber then comprises, for example, one or more other inlets similar to the second inlet. Additionally or alternatively, the spraying device then comprises, for example, successive injection chambers connected in series, the successive mixture being, for example, injected at the first inlet of the injection chambers.

The injection chamber 16 delimits a volume comprising a cylindrical portion.

The first inlet 22 is provided with an injector 26 as described below.

The first component is injected into the injection chamber 16 via the injector 26.

The first and second components are injected into the injection chamber 16.

The injector 26 has a longitudinal direction X.

The first inlet 22 emerges in the injection chamber in the longitudinal direction X, with the injector 26 extending across the first inlet.

The cylindrical portion of the volume has a cylindrical shape around the longitudinal direction X.

The first inlet 22 emerges in a base of the cylindrical portion.

The second inlet 24 emerges, for example, at right angles to the longitudinal direction X.

Alternatively, the second inlet 24 emerges at an angle to the longitudinal direction, for example at an angle of between 0° and 45°, preferably less than 25° and more preferably less than 10°.

Preferably, the second inlet 24 emerges at an angle, so that it is oriented towards the first inlet 22, i.e. the flow of product arriving via the second inlet has an opposite direction along the longitudinal direction X of the flow of product from the first inlet.

The second inlet 24 emerges into the injection chamber at the side wall delimiting the cylindrical portion.

The second inlet 24 emerges opposite the injector 26 in the longitudinal direction X.

In a particular embodiment, the second inlet is such that the jet of second component forms a vortex in the injection chamber, more particularly around the injector 26.

The vortex swirls around the longitudinal direction X.

The first and second components come into contact in the injection chamber 16 and mix.

The injection chamber comprises an outlet, the outlet here being fluidly connected to the inlet of a mixer 18, for example via an injector holder included in the mixer.

The mixer 18 here is a static mixer.

The outlet of the mixer 18 is fluidically connected, in this case directly connected, to the injector 14.

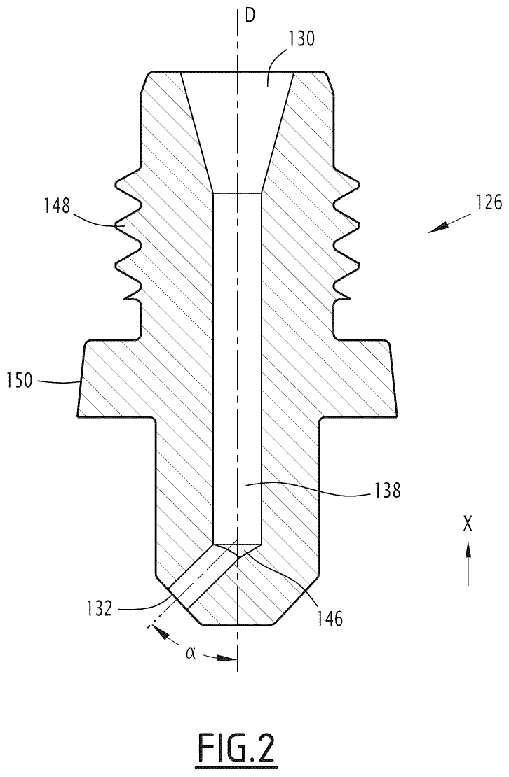

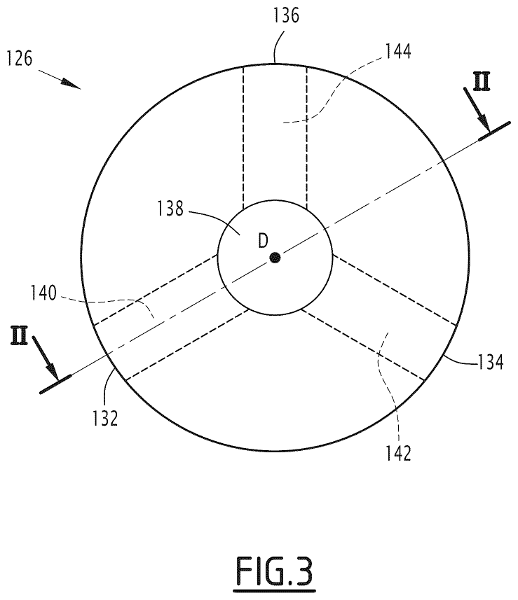

A first example of an injector 126 according to the invention will now be described in more detail with reference to FIGS. 2 and 3.

The injector 126 is, for example, made of a metallic material, preferably stainless steel. This helps to limit wear and tear.

The injector 126 has an inlet 130 and a plurality of outlet orifices 132, 134, 136.

The injector 126 comprises, for example, between two and five outlet orifices, preferably three outlet orifices.

The outlet orifices 132, 134, 136 are distributed over a circumference d of the injector 126 at regular angular intervals, the angular interval preferably being equal to 360° divided by the number of outlet orifices.

The injector 126 is adapted to be supplied with a component product, here the first component, at the inlet 130, so that the component product flows through the outlet orifices 132, 134, 136.

Each outlet orifice 132, 134, 136 forms a given angle α with respect to the longitudinal direction of between 10° and 90°, preferably between 30° and 90°. In the example shown, the given angle α is equal to 45°, without limiting the disclosure of this first example to this value.

The angle of an outlet orifice 132, 134, 136 corresponds to the angle of a jet leaving said outlet orifice.

More particularly, the respective angles given for each outlet orifice 132, 134, 136 are equal to each other.

The given angle α is oriented such that the component product leaves the outlet orifices with a flow oriented along the longitudinal direction X opposite the inlet 130.

The injector 126 has a central axis D, the central axis D extending in the longitudinal direction X.

The inlet 130 here is centered on the central axis D.

The external shape of the injector 126 is, for example, rotationally symmetrical about the central axis D.

The injector 126 here comprises a central channel 138 extending from the inlet 130 and secondary channels 140, 142, 144, each secondary channel 140, 142, 144 connecting a respective outlet orifice 132, 134, 136 to the central channel 138.

The cross-sectional area of the central channel 138 is strictly smaller than the cross-sectional area of the inlet 130.

The injector also acts as a restrictor.

In particular, this allows injection pressures to be balanced so that flow regulation at the restrictor can be better controlled. The hardener component regularly has a much lower viscosity than the resin and/or the quantity of hardener to be injected, here at the restrictor, is smaller than the quantity of resin, for example with a ratio of between 1:4 and 1:15.

More particularly, the inlet 130 has a conical shape, such that the cross-sectional area strictly decreases from upstream to downstream.

The cross-sectional area of the central channel 138 is, for example, equal to the sum of the passage cross-sections of the secondary channels 140, 142, 144.

In particular, this avoids additional pressure losses when restricting channel 130 to channel 138.

The central channel 138 extends along the longitudinal direction X, more particularly along the central axis D.

The central channel 138 is straight here.

The central channel 138 is a cylindrical channel.

The cylinder axis of the central channel 138 is the central axis D.

The central channel 138 extends from the inlet 130 to an intermediate intersection 146.

Each secondary channel 140, 142, 144 extends from the intermediate intersection 146 to the respective outlet orifice 132, 134, 136.

In this way, the inlet 130 is fluidically connected to each outlet orifice by the central channel 138, then the corresponding secondary channel 140, 142, 144.

Each secondary channel 140, 142, 144 here extends in a plane, the plane forming the given angle α with the longitudinal direction X, more particularly here with the central axis D.

Each secondary channel 140, 142, 144 is straight.

More particularly, each secondary channel 140, 142, 144 forms the given angle α with respect to the longitudinal direction X, more particularly here with the central axis D.

Here, each secondary channel 140, 142, 144 has a central axis of extension, the central axis of extension being secant with the central axis D.

Each secondary channel 140, 142, 144 is a cylindrical channel.

Each secondary channel 140, 142, 144 extends from the intermediate intersection 126 to the corresponding outlet orifice.

The injector 126 also comprises a thread 148 to be held in the first inlet, the first inlet having a complementary thread.

This thread allows the injector to be fitted and removed for maintenance or cleaning.

The injector 126 also comprises a shoulder 150.

The shoulder 150 has a conical shape, adapted to receive a plastic seal, the plastic seal being a ring, so as to improve the seal between the injector and the sprayer body.

The injector 126 according to the first example is able to eject the component product in several jets, for example three here, at an angle to the longitudinal direction of the injector. This encourages mixing with a second component in the injection chamber, as mentioned above.

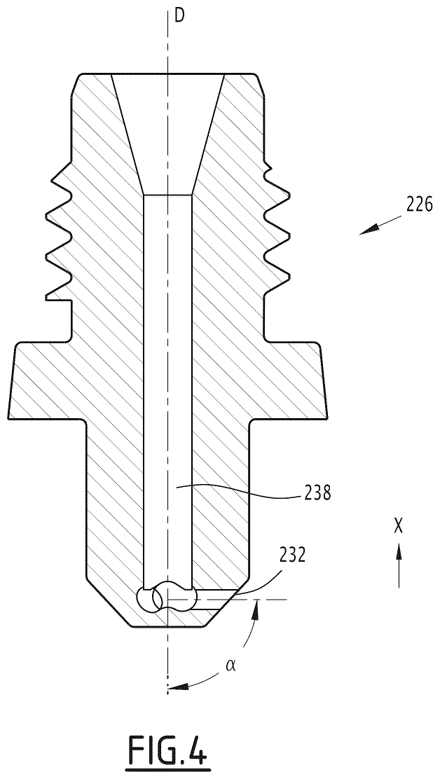

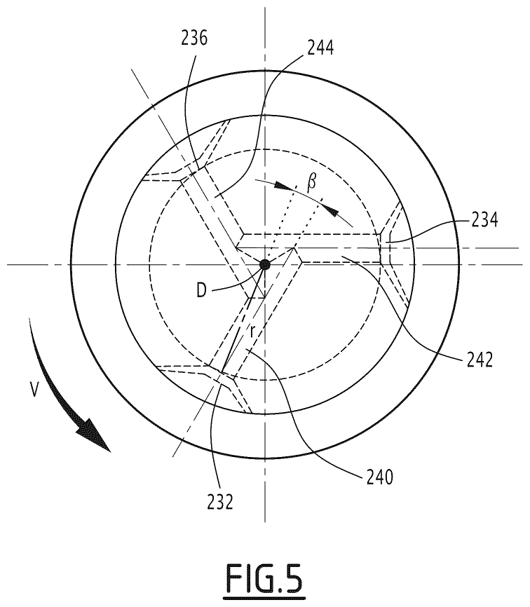

A second example of an injector 226 according to the invention will now be described in more detail with reference to FIGS. 4 and 5.

Items identical or similar to the first example will be numbered with the same reference incremented by 100.

For the sake of brevity, only the features in which this second example differs from the first will now be described.

In this second example shown, the given angle α is equal to 90°, without limiting the disclosure of this second example to this value. As before, each outlet orifice 232, 234, 236 forms a given angle α with respect to the longitudinal direction of between 10° and 90°, preferably between 30° and 90°.

The central channel 238 is similar to that in the first example.

The secondary channels 240, 242, 244 differ from the first example in that each outlet orifice further forms a second given angle β with respect to a respective radial direction r.

The respective radial direction r is the direction perpendicular to the longitudinal direction X and a local tangential direction, the local tangential direction corresponding to the tangential direction of the injector 226 at the location where the corresponding outlet orifice emerges, more particularly at the center of the corresponding outlet orifice.

The respective radial direction r is the direction perpendicular to the longitudinal direction X and connecting the central axis D and the center of the corresponding outlet orifice.

In this embodiment, the second given angle β is different from 0° and less than or equal to 35°, preferably between 0° (excluded) and 20°, and even more preferably between 5° and 15°.

Each secondary channel 240, 242, 244 here extends in a plane, the plane forming the given angle α with the longitudinal direction X.

Each secondary channel 240, 242, 244 is straight.

More particularly, each secondary channel 240, 242, 244 forms the given angle α with respect to the longitudinal direction X.

In the second example, each secondary channel 240, 242, 244 has a central axis of extension, the central axis of extension not being secant with the central axis D.

The distance between the central axis D and the respective central axis of extension is here such that the second given angle β is as previously described.

In this way, each secondary channel 240, 242, 244 is offset from the central axis D.

Each secondary channel 240, 242, 244 is a cylindrical channel.

Each secondary channel 240, 242, 244 extends from the intermediate intersection 126 to the corresponding outlet orifice.

The radial component of the outlet jet, thanks to the angle β, then leads to the formation of a vortex of the first component.

The presence of a radial component in the outlet jet promotes mixing directly within the injection chamber 16, in particular by promoting turbulence in the injection chamber 16.

In addition, advantageously, the outlet orifices 232, 234, 236 here are such that the first component is injected with a flow radially opposite to the second component vortex, represented by arrow V in FIG. 5, where applicable.

Injectors according to the invention therefore make it possible to promote mixing of the components of a coating product, and thus to improve the quality of the sprayed coating product.

1. An injector for a multi-component coating material spraying device, the injector having a longitudinal direction, the injector comprising:
an inlet for supplying the injector with a component product; and
a plurality of outlet orifices where the component product exits the injector, each outlet orifice forming a given angle with respect to the longitudinal direction of between 10° and 90°, and wherein each outlet orifice further forms a second given angle with respect to a respective radial direction, the respective radial direction being the direction perpendicular to the longitudinal direction and to a local tangential direction, the local tangential direction corresponding to the tangential direction of the injector at the point where the outlet orifice emerges, the second given angle being other than 0° and less than or equal to 35°.

2. The injector according to claim 1, further comprising:
a central channel extending from said inlet; and
secondary channels, each secondary channel connecting a respective outlet orifice to said central channel.

3. The injector according to claim 2, wherein each secondary channel extends in a plane, the plane forming the given angle with the longitudinal direction.

4. The injector according to claim 2, wherein said central channel extends in the longitudinal direction.

5. The injector according to claim 2, wherein the cross-sectional area of said central channel is equal to the sum of the passage cross-sections of said secondary channels.

6. The injector according to claim 1, wherein said outlet orifices are distributed over a circumference of the injector at regular angular intervals.

7. The injector according to claim 6, wherein the angular interval is equal to 360° divided by the number of said outlet orifices.

8. The injector according to claim 1, comprising between two and five outlet orifices.

9. The injector according to claim 1, comprising three outlet orifices.

10. The injector according to claim 1, wherein the injector comprises a central channel extending from said inlet, the cross-sectional area of the central channel being strictly less than any cross-sectional area of said inlet.

11. The injector according to claim 1, further comprising a thread for mounting and dismounting the injector on an inlet of an injection chamber.

12. The injector according to claim 1, wherein each outlet orifice forms a given angle with respect to the longitudinal direction of between 30° and 90.

13. The injector according to claim 1, wherein the second given angle is between 0° exclusive and 20°.

14. The injector according to claim 1, wherein the second given angle is between 5° and 15°.

15. A multi-component coating product spraying device comprising:
a spraying element;
an injector; and
an injection chamber upstream of said injector, comprising:
a first inlet for a first component of the coating product comprising an injector according to claim 1; and
a second inlet for a second component of the coating product,
wherein the injector injects the coating product into said spraying element and injects the first component into said injection chamber, and said spraying element sprays the coating product.

16. The spraying device according to claim 15, wherein said second inlet is such that the second component forms a vortex in said injection chamber, the outlet orifices of said injector being such that the first component is injected with a flow having a radial component opposite to the vortex.
